(19) United States
(12) Patent Application Publication
(10) Pub. No.: US 2019/0113703 A1
(43) Pub. Date: Apr. 18, 2019

(54) Fiber Optic Drop Cable

(71) Applicant: Superior Essex International LP, Atlanta, GA (US)

(72) Inventors: Thomas Christopher Cook, Woodstock, GA (US); Jeffrey Scott Laws, Brownwood, TX (US)

(21) Appl. No.: 15/730,824

(22) Filed: Oct. 12, 2017

(51) Int. Cl. G02B 6/44; G02B 6/02

(52) U.S. Cl. CPC G02B 6/4433; G02B 6/4494; G02B 6/4403; G02B 6/4497; G02B 6/02314; G02B 6/4434; G02B 6/4486; G02B 6/4429

(57) ABSTRACT

A fiber optic drop cable may include a buffer tube having a diameter between approximately 2.20 mm and approximately 3.20 mm to facilitate housing of at least twelve optical fibers. First and second strength rod may be respectively positioned on opposite sides of the buffer tube, and each strength rod may have a diameter between approximately 1.25 mm and approximately 2.10 mm. Additionally, a jacket may be formed around the buffer tube and the strength rods. The jacket may have an elongated cross-sectional shape with a major dimension between approximately 8.0 mm and approximately 9.5 mm and a minor dimension between approximately 4.0 mm and approximately 4.4 mm.

### TECHNICAL FIELD

Embodiments of the disclosure relate generally to fiber optic drop cables and, more specifically, to high fiber count drop cables having a relatively small cross-sectional profile.

### BACKGROUND

Optical fiber drop cables are typically used to provide various locations, such as residences and businesses, with fiber optic service. Typically, a drop cable extends from an outside communication device (e.g., a terminal at a curb, a box mounted on a pole, etc.) to an inside communication device. In various applications, portions of a drop cable may be buried, suspended via clamps, routed through walls, and/or routed through ducts. As such, the drop cable may be subject to a wide variety of physical stresses. Additionally, at least portions of the drop cable may be subject to a wide variety of environmental conditions, such as temperature fluctuations.

With customer demand for ever increasing bandwidth, it is desirable to incorporate a greater number of optical fibers into fiber optic drop cables. However, it is also desirable for a fiber optic drop cable to have a relatively small cross-sectional shape and/or profile, thereby facilitating easier routing and installation of the cable. Accordingly, there is an opportunity for improved fiber optic drop cables that include a greater number of optical fibers than conventional drop cables with a similar cross-sectional profile and environmental performance.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items; however, various embodiments may utilize elements and/or components other than those illustrated in the figures. Additionally, the drawings are provided to illustrate example embodiments described herein and are not intended to limit the scope of the disclosure.

FIG. 1 is a cross-sectional view of an example fiber optic drop cable, according to an illustrative embodiment of the disclosure.

FIG. 2 is a cross-sectional view of another example fiber optic drop cable, according to an illustrative embodiment of the disclosure.

### DETAILED DESCRIPTION

Various embodiments of the present disclosure are directed to fiber optic drop cables having a greater fiber count than conventional cables with a similar cross-sectional size. Accordingly, the disclosed fiber optic drop cables can be utilized in the same manner as conventional drop cables while providing improved bandwidth. In example embodiments, a fiber optic drop cable may include a buffer tube that is sized to accommodate a larger number of optical fibers than a conventional cable. For example, the buffer tube may be sized to accommodate at least twenty-four (24) optical fibers while conventional cables include buffer tubes cable of accommodating. In certain embodiments, the fiber optic drop cable may include a single buffer tube. The buffer tube may be formed with a wide variety of suitable dimensions that facilitate housing the optical fibers within acceptable or desirable performance parameters, such as fiber strain and/or excess fiber length parameters. In certain embodiments, the buffer tube may have a diameter between approximately 2.20 mm and approximately 3.20 mm.

Additionally, the fiber optic drop cable may include two strength rods that are respectively positioned on either side of the buffer tube. In other words, along a cross-section of the drop cable, the two strength rods and the buffer tube may be arranged in a side-by-side or in-line configuration. Each strength rod may be formed from a wide variety of suitable materials and/or with a wide variety of suitable dimensions. In certain embodiments, each strength rod may be formed from one or more dielectric materials. For example, each strength rod may be a glass reinforced fiber strength rod. In certain embodiments, each strength rod may have a diameter between approximately 1.25 mm and approximately 2.10 mm. In other embodiments, each strength rod may have a cross-sectional area between approximately 1.22 mm² and approximately 3.46 mm².

A jacket may be formed around the buffer tube and the strength rods. Given the side-by-side arrangements of the buffer tube and strength rods, formation of the jacket may result in the drop cable having an elongated cross-sectional shape. For example, the cable may have an elliptical cross-sectional shape, a rectangular cross-sectional shape, or any other suitable cross-sectional shape having a major and a minor dimension (e.g., a width that is greater than a height or thickness, etc.). As desired, the top and bottom surfaces of the jacket may be relatively flat or, alternatively, substantially parallel with one another. In other words, the drop cable may be formed as a relatively flat drop cable. In certain embodiments, the jacket may have a major dimension between approximately 8.0 mm and approximately 9.5 mm, and the jacket may also have a minor dimension between approximately 4.0 mm and approximately 4.4 mm.

Although the outer jacket of the drop cable may have dimensions that are similar to those of conventional drop cables, the other components of the drop cable may result in the drop cable satisfying any number of desirable performance characteristics and/or requirements. For example, the drop cable may satisfy the Telcordia GR-20 requirements associated with 300-pound drop cables. In certain embodiments, when a 300 pound tensile load is applied to the drop cable for one hour, at least 90% of the optical fibers included in the drop cable will experience attenuation of less than or equal to approximately 0.05 dB at a wavelength of approximately 1550 mm and 100% of the optical fibers will experience attenuation of less than or equal to 0.15 dB at a wavelength of approximately 1550 nm. Additionally, the optical fibers will experience a fiber strain that is less than or equal to approximately 0.40%. In other embodiments, when a 90 pound tensile load is applied to the drop cable for ten minutes, at least 90% of the optical fibers included in the drop cable will experience attenuation of less than or equal to approximately 0.05 dB at a wavelength of approximately 1550 nm and 100% of the optical fibers will experience attenuation of less than or equal to 0.15 dB at a wavelength of approximately 1550 nm. Additionally, the optical fibers will experience a fiber strain that is less than or equal to approximately 0.10%. As desired in certain embodiments, the drop cable may have a compressive strength that permits similar optical fiber attenuation performance (at least 90% of fibers having an attenuation of less than 0.05 dB and 100% of fibers having an attenuation of less than 0.15 dB) may be achieved when an incidental compressive load of 220 N/cm and/or a long term load of 110 N/cm is applied to the drop cable. In various embodiments, the drop cable may have an impact resistance that permits similar optical fiber attenuation performance to be achieved when a one kilogram weight impacts the cable three times from a distance of approximately thirty centimeters (30 cm).

Certain example embodiments of the disclosure now will be described more fully hereinafter with reference to the accompanying drawings, in which certain embodiments of the disclosure are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

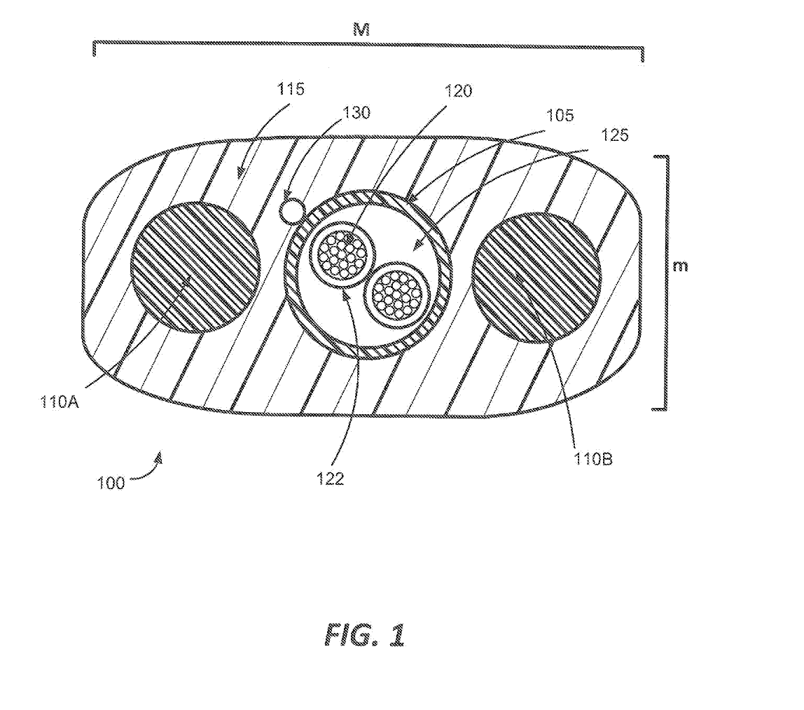

FIG. 1 depicts a cross-sectional view of an example fiber optic drop cable 100, according to an illustrative embodiment of the disclosure. The drop cable 100 may be suitable for use in a wide variety of applications including, but not limited to, application in which the drop cable is buried, installed in or routed through a conduit, or suspended in an aerial environment (e.g., suspended and held via one or more P-clamps or other clamps, etc.). Further, although the cable 100 is described as a drop cable, the cable 100 may additionally or alternatively be utilized as a horizontal cable, vertical cable, plenum cable, riser cable, or as any other suitable type of cable.

The illustrated drop cable 100 may include a buffer tube 105, at least two strength rods 110A, 110B or strength members, and a jacket 115 formed around the buffer tube 105 and the strength rods 110A, 110B. According to an aspect of the disclosure, the buffer tube 105 and the strength rods 110A, 110B may be arranged in a side-by-side or in-line configuration. For example, the two strength rods 110A, 110B may be positioned on opposite sides of the buffer tube 105. In certain embodiments, the strength rods 110A, 110B and the buffer tube 105 may be positioned along a line that bisects the drop cable along its major dimension (e.g., its width dimension).

The buffer tube 105 may be configured to contain or house optical fibers 120. Any number of optical fibers, other transmission elements, and/or other components may be positioned within the buffer tube 105. In certain embodiments, optical fibers 120 may be loosely positioned in a tube, wrapped or bundled together, or provided in one or more ribbons or ribbon stacks. In certain embodiments, the cable 100 may include a single buffer tube 105. In other words, the buffer tube 105 may be the only buffer tube incorporated into the cable 100. In other embodiments, the cable 100 may include a plurality of buffer tubes.

The buffer tube 105 may be formed with any suitable cross-sectional shapes and/or dimensions. For example, the buffer tube 105 may have a circular cross-sectional shape. As another example, the buffer tube 105 may have an inner diameter that facilitates the housing of a desired number of optical fibers 120. For example, the buffer tube 105 may be sized such that it can accommodate at least twenty-four (24) optical fibers with acceptable or desirable excess fiber length, fiber strain, and/or other suitable parameters. By contrast, similar single tube drop cables may include buffer tubes that are sized to accommodate twelve optical fibers. Additionally, the buffer tube 105 may be formed with a wide variety of suitable diameters, such as a wide variety of suitable outer diameters. In certain embodiments, the buffer tube 105 may have a diameter between approximately 2.20 mm and approximately 3.20 mm. In one example, embodiment, the buffer tube 105 may have a diameter of approximately 3.0 mm. In other embodiments, the buffer tube 105 may have a diameter of approximately 2.20, 2.25, 2.30, 2.40, 2.50, 2.60, 2.70, 2.75, 2.80, 2.90, 3.0, 3.10, or 3.20 mm, a diameter incorporated into a range between any two of the above values, or a diameter included in a range bounded on either a minimum or maximum end by one of the above values.

The buffer tube 105 may be formed from any suitable materials or combinations of materials. Examples of suitable materials include, but are not limited to, various polymers or polymeric materials, acrylate or acrylics (e.g., acrylic elastomers, etc.), polyvinyl chloride (“PVC”), polyurethane, a fluoropolymer, polyethylene, neoprene, polyvinylidene fluoride (“PVDF”), polybutylene terephthalate (“PBT”), ethylene, plastic, or other appropriate materials or combinations of suitable materials. In one example embodiment, the buffer tube 105 may be formed from PBT or from a material that includes PBT. Additionally, a buffer tube 105 may be formed as either a single layer or a multiple layer buffer tube. In the event that multiple layers are utilized, the layers may all be formed from the same material(s) or, alternatively, at least two layers may be formed from different materials or combinations of materials. For example, at least two layers may be formed from different polymeric resins. As another example, a flame retarding or other suitable additive may be incorporated into a first layer but not into a second layer.

Any number of optical fibers 120 may be housed within the buffer tube 105 as desired in various embodiments. In certain embodiments, at least twenty-four optical fibers 120 may be housed or positioned within the buffer tube 105. Each optical fiber may be a single mode fiber, multi-mode fiber, pure-mode fiber, polarization-maintaining fiber, multi-core fiber, or some other optical waveguide that carries data optically. Additionally, each optical fiber may be configured to carry data at any desired wavelength (e.g., 1310 nm, 1550 nm, etc.) and/or at any desired transmission rate or data rate. The optical fibers may also include any suitable composition and/or may be formed from a wide variety of suitable materials capable of forming an optical transmission media, such as glass, a glassy substance, a silica material, a plastic material, or any other suitable material or combination of materials. Each optical fiber may also have any suitable cross-sectional diameter or thickness. In certain embodiments, an optical fiber may include a core that is surrounded by a cladding. Additionally, one or more suitable coatings may surround the cladding.

In certain embodiments, a plurality of optical fibers 120 may be loosely positioned within the buffer tube 105. In other embodiments, a plurality of optical fibers 120 may be arranged into one or more suitable bundles or groupings. For example, twenty-four optical fibers 120 may be arranged into two twelve fiber groups. A wide variety of other numbers of groupings may be utilized in other embodiments, and each grouping may have any suitable number of optical fibers. As desired, each group of fibers may include one or more suitable wraps or binders 122 that maintains the fibers in a group. For example, a wrap or binder 122 may be helically wrapped around the fibers in a group. Examples of suitable binders include, but are not limited to, identification threads (e.g., a colored thread that facilitates identification of a group of optical fibers, etc.), water-blocking threads, strength yarns, etc.

In yet other embodiments, a plurality of optical fibers 120 may be arranged into one or more fiber ribbons and/or into a ribbon stack. For example, optical fibers may be formed or incorporated into a plurality of different ribbon arrangements that are stacked on top of one another to form a ribbon stack. As another example, optical fibers may be formed into one or more ribbon arrangements that are folded or otherwise manipulated into a stacked or other configuration. As yet another example, optical fibers may be arranged in one or more ribbons that each include intermittent, spaced, or spiderweb-type bonding that permits the ribbons to be bundled, rolled, and/or otherwise formed into a desired arrangement.

In certain embodiments, a suitable filling compound 125 may be utilize to fill the buffer tube 105. In other words, a filling compound 125 may be utilized to fill the interstitial spaces within the buffer tube 105 that are not occupied by optical fibers 120 (or other components). A wide variety of filling compounds 125 may be utilized as desired. For example, a water-blocking gel, such as Polymer Fiber Matrix (“PFM”) gel manufactured and marketed by Superior Essex International LP, may be utilized as a filling compound. The PFM gel may be a non-sticky, water-blocking material that reduces friction between the buffer tube and the optical fibers 120 while permitting easy cleaning of the optical fibers 120 during installation. Other suitable filling compounds, such as water-blocking gels, grease, foam materials, etc. may be utilized as desired. In other embodiments, the cable 100 may be formed as a “dry” cable that does not include a filling compound. As desired, water-blocking tapes, water-blocking wraps, water-blocking yarns, strength yarns (e.g., aramid yarns), water-blocking powders, moisture absorbing materials, and/or a wide variety of other suitable materials may be incorporated into the buffer tube 105. A dry water-blocking component may include any number of suitable water-blocking materials, such as super absorbent polymers (“SAP”) and/or other suitable materials. Additionally, a “dry” cable component may be formed as a relatively continuous layer that is incorporated into the buffer tube 105. For example, a “dry” cable component may be wrapped around, enclose, or entrap certain optical fibers 120. In other embodiments, a “dry” cable component may include a plurality of discrete components that are intermittently wrapped, partially wrapped, or otherwise positioned within the buffer tube 105 at any number of desired locations (e.g., a plurality of spaced locations, in a relatively continuous manner, etc.) along a longitudinal length of the cable 100.

In certain embodiments, one or more water-blocking components may additionally or alternatively be positioned outside of the buffer tube 105. For example, one or more water-blocking threads 130 may be wrapped around the buffer tube 105 or positioned adjacent to the buffer tube 105 within the cable 100. As another example, a water-blocking tape may be wrapped around the buffer tube 105. Indeed, a water-blocking component may be formed with a wide variety of suitable constructions (e.g., yarns, tapes, etc.). Additionally, a water-blocking component may include any number of suitable water-blocking materials, such as super absorbent polymers (“SAP”) and/or other suitable materials. Additionally, a water-blocking component may be formed as a relatively continuous layer that is incorporated into the cable 100. For example, a water-blocking component may be a continuous component that is wrapped around or positioned adjacent to the buffer tube 105. In other embodiments, a water-blocking component may include a plurality of discrete components that are intermittently wrapped, or otherwise positioned about the buffer tube 105 at any number of desired locations (e.g., a plurality of spaced locations, in a relatively continuous manner, etc.) along a longitudinal length of the cable 100.

With continued reference to FIG. 1, at least two strength rods 110A, 110B may be incorporated into the cable 100. For example, two longitudinally extending strength rods 110A, 110B may be positioned on opposite sides of the buffer tube 105. The buffer tube 105 and the strength rods 110A, 110B may be arranged in a side-by-side or in-line configuration. In certain embodiments, the strength rods 110A, 110B and the buffer tube 105 may be positioned along a line that bisects the drop cable 100 along its major dimension (e.g., its width dimension). Additionally, in certain embodiments, only two strength rods 110A, 110B having dimensions similar to those discussed below may be incorporated into the cable 100. In other embodiments, any other suitable number of strength rods may be incorporated into the cable 100.

Each strength rod (generally referred to as strength rod 110) may be formed with any suitable cross-sectional shape and/or dimensions. For example, in certain embodiments, a strength rod 110 may have a circular cross-sectional shape. In other embodiments, a strength rod 110 may be formed with an elliptical, square, rectangular, hexagonal, octagonal, or any other suitable cross-sectional shape. Additionally, the strength rod 110 may be formed with any suitable dimensions, such as any suitable diameter and/or cross-sectional area. In certain embodiments, a strength rod 110 may have a diameter between approximately 1.25 mm and approximately 2.10 mm. In one example, embodiment, a strength rod 110 may have a diameter of approximately 1.65 mm. In other embodiments, a strength rod 110 may have a diameter of approximately 1.25, 1.30, 1.35, 1.40, 1.45, 1.50, 1.55, 1.60, 1.65, 1.70, 1.75, 1.80, 1.85, 1.90, 1.95, 2.0, 2.05, or 2.10 mm, a diameter incorporated into a range between any two of the above values, or a diameter included in a range bounded on either a minimum or maximum end by one of the above values.

Additionally or alternatively, in certain embodiments, a strength rod 110 may have a cross-sectional area between approximately 1.22 mm² and approximately 3.46 mm². In one example, embodiment, a strength rod 110 may have a cross-sectional area of approximately 2.14 mm². In other embodiments, a strength rod 110 may have a cross-sectional area of approximately 1.22, 1.33, 1.43, 1.54, 1.65, 1.77, 1.88, 2.0, 2.01, 2.14, 2.27, 2.40, 2.54, 2.69, 2.83, 2.98, 3.14, 3.30, or 3.46 mm², cross-sectional area incorporated into a range between any two of the above values, or cross-sectional area included in a range bounded on either a minimum or maximum end by one of the above values.

A strength rod 110 may be formed with a wide variety of suitable constructions. In certain embodiments, a strength rod 110 may be formed as a solid strength rod. In other embodiments, a strength rod 110 may be formed as a hollow or a partially hollow strength rod (e.g., a strength rod that includes one or more internal cavities and/or supports, etc.). A strength rod 110 may also be formed from a wide variety of suitable materials and/or combinations of material. For example, a strength rod 110 may be formed from one or more dielectric materials. In various embodiments, a strength rod 110 may be formed as a plastic rod, a fiber-reinforced plastic (“FRP”) rod, a glass-reinforced plastic (“GRP”) rod, a fiberglass rod, or from any other suitable material or combination of materials. In certain embodiments, a strength rod 110 may be formed as a GRP rod. Additionally, in certain embodiments, a strength rod 110 may be formed with a single layer of material. In other embodiments, a strength rod 110 may be formed with a plurality of different layers of material. Further, in certain embodiments, each of the strength rods 110A, 110B included in the cable 100 may be formed with the same dimensions and/or constructions. In other embodiments, at least two strength rods may be formed with different dimensions, material constructions, layer constructions, and/or other parameters.

With continued reference to FIG. 1, an outer jacket 115 may be formed around the buffer tube 105 and the strength rods 110A, 110B. The jacket 115 may define an outer periphery of the cable 100. The jacket 115 may enclose the internal components of the cable 100, seal the cable 100 from the environment, and provide strength and structural support. The jacket 115 may be formed from a wide variety of suitable materials, such as a polymeric material, polyvinyl chloride (“PVC”), polyurethane, one or more polymers, a fluoropolymer, polyethylene, medium density polyethylene (“MDPE”), neoprene, chlorosulfonated polyethylene, polyvinylidene fluoride (“PVDF”), polypropylene, modified ethylene-chlorotrifluoroethylene, fluorinated ethylene propylene (“FEP”), ultraviolet resistant PVC, flame retardant PVC, low temperature oil resistant PVC, polyolefin, flame retardant polyurethane, flexible PVC, low smoke zero halogen (“LSZH”) material, plastic, rubber, acrylic, or some other appropriate material known in the art, or a combination of suitable materials. In certain embodiments, the jacket 115 may be formed from MDPE. As desired, the jacket 115 may also include flame retardant materials, smoke suppressant materials, carbon black or other suitable material for protection against exposure to ultraviolet (“UV”) light, and/or other suitable additives. The jacket 115 may include a single layer or, alternatively, multiple layers of material (i.e., multiple layers of the same material, multiple layers of different materials, etc.). As desired, the jacket 115 may be characterized as an outer sheath, a casing, a circumferential cover, or a shell.

The jacket 115 may enclose one or more openings in which other components of the cable 100, such as the buffer tube 105 and the strength rods 110A, 110B, are disposed. At least one opening enclosed by the jacket 115 may be referred to as a cable core, and any number of suitable cable components may be disposed in a cable core. In the cable 100 illustrated in FIG. 1, the buffer tube 105 may be situated within a cable core. A wide variety of other components may be situated within a cable core as desired, such as other transmission media, a power conductor, et. Indeed, a wide variety of different cable constructions may be utilized in accordance with various embodiments of the disclosure.

Additionally, the illustrated cable 100 has an elongated or approximately flat cross-sectional profile. For example, the jacket 115 may be formed with an elliptical or other elongated cross-sectional shape having a major dimension “M” (e.g., a width dimension) that is greater than a minor dimension “m” (e.g., a thickness or height dimension.). In certain embodiments, the jacket 115 may have top and bottom surfaces that are parallel, substantially parallel, or approximately parallel, thereby resulting in a flat or relatively flat drop cable 100. The cross-sectional profile of the jacket 115 may facilitate use of the cable 100 with industry standard P-clamps that are utilized in association with relatively flat drop cables. In other embodiments, other cross-sectional profiles (e.g., a rectangular profile, etc.) may be utilized as desired. In certain embodiments, at least one “ripcord” may be incorporated into the cable 100, for example, within a cable core. A ripcord may facilitate separating the jacket 115 from other components of the cable 100. In other words, the ripcord may help open the cable 100 for installation or field service. A technician may pull the ripcord during installation in order to access internal components of the cable 100.

The jacket 115 may also be formed with a wide variety of suitable dimensions. For example, the jacket 115 may be formed with a major dimension “M” between approximately 8.0 mm and approximately 9.50 mm. In various embodiments, the jacket 115 may be formed with a major dimension “M” of approximately 8.0, 8.10, 8.20, 8.25, 8.30, 8.40, 8.50, 8.60, 8.70, 8.75, 8.80, 8.90, 9.90 9.10, 9.20, 9.25, 9.30, 9.40, or 9.50 mm, a major dimension “M” included in a range between any two of the above values, or a major dimension “M” included in a range bounded on either a minimum or maximum end by one of the above values. The jacket 115 may also have a minor dimension “m” between approximately 4.0 mm and approximately 4.40 mm. In various embodiments, the jacket 115 may have a minor dimension “” of approximately 4.0, 4.05, 4.10, 4.15, 4.20, 4.25, 4.30, 4.35, or 4.40 mm, a minor dimension “m” included in a range between any two of the above values, or a minor dimension “m” included in a range bounded on either a minimum or maximum end by one of the above values. Other dimensions may be utilized as desired in other embodiments.

Although the outer jacket 115 of the drop cable 100 may have dimensions that are similar to those of conventional drop cables (e.g., conventional drop cables that house a smaller number of optical fibers, etc.), the combination of components of the cable 100 may result in the cable 100 satisfying any number of desirable performance characteristics and/or requirements. For example, the drop cable may satisfy the Telcordia GR-20 requirements associated with 300-pound drop cables. In certain embodiments, when a 300 pound tensile load is applied to the drop cable 100 for one hour, at least 90% of the optical fibers 120 included in the drop cable 100 will experience attenuation of less than or equal to approximately 0.05 dB at a wavelength of approximately 1550 mm, and 100% of the optical fibers 120 will experience attenuation of less than or equal to 0.15 dB at a wavelength of approximately 1550 nm. Additionally, the optical fibers 120 will experience a fiber strain that is less than or equal to approximately 0.40%.

In other embodiments, when a 90 pound tensile load is applied to the drop cable 100 for ten minutes, at least 90% of the optical fibers 120 included in the drop cable 100 will experience attenuation of less than or equal to approximately 0.05 dB at a wavelength of approximately 1550 nm, and 100% of the optical fibers 120 will experience attenuation of less than or equal to 0.15 dB at a wavelength of approximately 1550 nm. Additionally, the optical fibers 120 will experience a fiber strain that is less than or equal to approximately 0.10%.

As desired in certain embodiments, the drop cable 100 may have a compressive strength that permits similar optical fiber attenuation performance. For example, when an incidental compressive load of 220 N/cm (approximately 125 foot pounds/inch) is applied to the drop cable 100, at least 90% of the optical fibers 120 included in the drop cable 100 will experience attenuation of less than or equal to approximately 0.05 dB at a wavelength of approximately 1550 nm, and 100% of the optical fibers 120 will experience attenuation of less than or equal to 0.15 dB at a wavelength of approximately 1550 nm. As another example, when a long-term compressive load of 110 N/cm (approximately 63 foot pounds/inch) is applied to the drop cable 100, at least 90% of optical fibers 120 included in the drop cable 100 will experience attenuation of less than or equal to approximately 0.05 dB at a wavelength of approximately 1550 nm, and 100% of the optical fibers 120 will experience attenuation of less than or equal to 0.15 dB at a wavelength of approximately 1550 nm.

In certain embodiments, the drop cable may have an impact resistance that permits similar optical fiber attenuation performance to be achieved. For example, when a one kilogram weight impacts the cable three times from a distance of approximately thirty centimeters (30 cm), at least 90% of the optical fibers 120 included in the drop cable 100 will experience attenuation of less than or equal to approximately 0.05 dB at a wavelength of approximately 1550 nm, and 100% of the optical fibers 120 will experience attenuation of less than or equal to 0.15 dB at a wavelength of approximately 1550 nm.

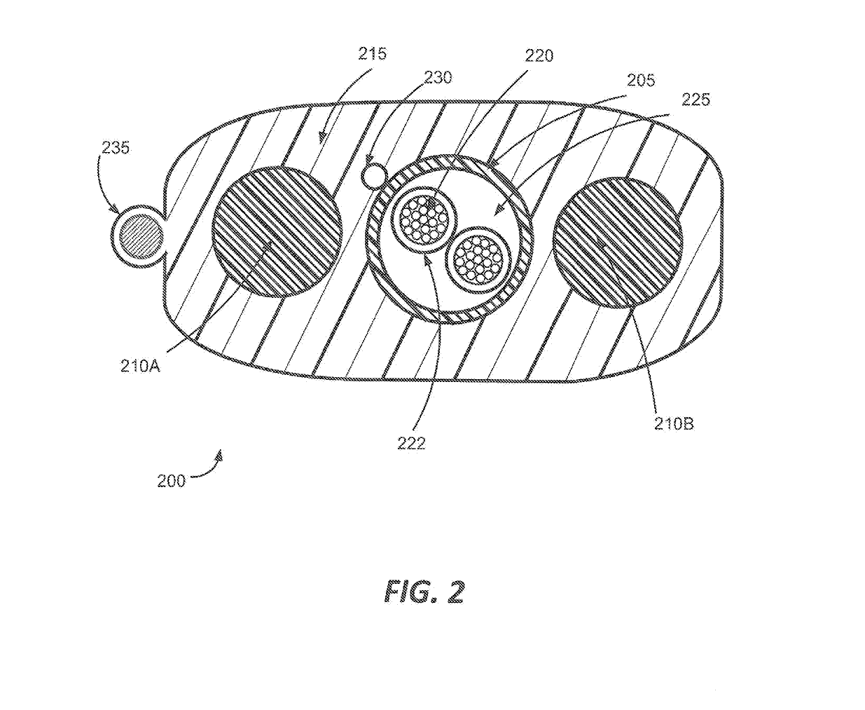

FIG. 2 depicts a cross-sectional view of another example cable 200, according to an illustrative embodiment of the disclosure. The drop cable 200 may include components that are similar to those of the drop cable 100 depicted in FIG. 1 and described in greater detail above. For example, the drop cable 200 may include a buffer tube 205, at least two strength rods 210A, 210B or strength members arranged in a side-by-side or in-line configuration with the buffer tube 205 (e.g., on opposite sides of the buffer tube 205, etc.), and a jacket 215 formed around the buffer tube 205 and the strength rods 210A, 210B. A plurality of optical fibers 220 (e.g., at least twelve optical fibers, etc.) may be positioned within the buffer tube 205, and the optical fibers 220 may optionally be arranged into any number of desirable groupings with suitable binders 222. As desired, the buffer tube 205 may be filled with a suitable filling compound 225. Additionally, any number of water-blocking components, such as water-blocking threads 230, may be positioned within, around, and/or adjacent to the buffer tube 205. Each of these components may be similar to the corresponding components described above with reference to FIG. 1.

With continued reference to FIG. 2, the cable 200 may include at least one conductive tone wire 235 or toncable unit that facilitates easy location of the cable 200 after installation. As shown, in certain embodiments, the tone wire 235 may be positioned on an outer periphery or near an outer surface of the cable jacket 235. For example, the tone wire 235 may be positioned at or near a side edge (e.g., a left or right edge, etc.) of the jacket 235. In other embodiments, the tone wire 235 may be positioned within one or more cable cores or proximate to one or more internal components of the cable 200. Additionally, the tone wire 235 may include any suitable wire or element that facilitates location of the cable 200 after installation (e.g., location utilizing a metal detector, location via identification of a signal transmitted via the tone wire, etc.). For example, the tone wire 235 may include one or more metallic conductors, such as a copper conductor (e.g., a solid conductor, a stranded conductor, etc.) or other suitable conductor formed from a metallic material, metallic alloy, or material capable of transmitting an electrical signal. Additionally, the tone wire 235 may be formed with a wide variety of suitable dimensions. For example, the tone wire 235 may be formed as a 24 American Wire Gauge (“AWG”) conductor.

The cables 100, 200 illustrated in FIGS. 1-2 are provided by way of example only to illustrate a few drop cable constructions that may incorporate at least twelve optical fibers in a relatively small cross-sectional profile. A wide variety of other components may be incorporated into a cable as desired in other embodiments. For example, a cable may include a wide variety of suitable transmission media, a wide variety of different types of tubes, strength members, water-blocking materials, water-swellable materials, insulating materials, dielectric materials, flame retardants, flame suppressants or extinguishants, gels, fillers, and/or other materials. Additionally, a cable may be designed to satisfy any number of applicable cable standards.

Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or operations. Thus, such conditional language is not generally intended to imply that features, elements, and/or operations are in any way required for one or more embodiments or that one or more embodiments necessarily include logic for deciding, with or without user input or prompting, whether these features, elements, and/or operations are included or are to be performed in any particular embodiment.

Many modifications and other embodiments of the disclosure set forth herein will be apparent having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purpose of limitation.

Although specific embodiments have been described above in detail, the description is merely for purposes of illustration. It should be appreciated, therefore, that many aspects described above are not intended as required or essential elements unless explicitly stated otherwise. Various modifications of, and equivalent acts corresponding to, the disclosed aspects of the exemplary embodiments, in addition to those described above, can be made by a person of ordinary skill in the art, having the benefit of the present disclosure, without departing from the spirit and scope of the invention defined in the following claims, the scope of which is to be accorded the broadest interpretation so as to encompass such modifications and equivalent structures.

1. A fiber optic drop cable, comprising:
a buffer tube having a diameter between 2.20 mm and 3.20 mm;
a plurality of optical fibers disposed within the buffer tube;
first and second strength rods respectively positioned on opposite sides of the buffer tube, each strength rod having a diameter between 1.25 mm and 2.10 mm; and
a jacket formed around the buffer tube and the first and second strength rods, the jacket comprising an elongated cross-sectional shape with a major dimension between 8.0 mm and 9.5 mm and a minor dimension between 4.0 mm and 4.4 mm,
wherein, when a tensile load of 300 pounds is applied to the fiber optic drop cable for one hour, at least ninety percent of the plurality of optical fibers have an attenuation of less than or equal to 0.05 dB at 1550 nm.

2. The fiber optic drop cable of claim 1, wherein the buffer tube comprises polybutylene terephthalate.

3. The fiber optic drop cable of claim 1, further comprising a water-blocking gel positioned within the buffer tube.

4. The fiber optic drop cable of claim 1, wherein the plurality of optical fibers comprises at least twenty-four optical fibers.

5. The fiber optic drop cable of claim 1, wherein the first and second strength rods comprise glass reinforced plastic strength rods.

6. The fiber optic drop cable of claim 1, wherein the jacket comprises polyethylene.

7. the fiber optic drop cable of claim 1, further comprising a conductive tone wire.

8. A fiber optic drop cable, comprising:
a longitudinally extending buffer tube and two longitudinally extending strength rods arranged in a side-by-side configuration, with the strength rods positioned on opposite sides of the buffer tube;
at least twenty-four optical fibers positioned within the buffer tube; and
a jacket formed around the buffer tube and the two strength rods, the jacket comprising an elongated cross-section shape with a major dimension between 8.0 mm and 9.5 mm and a minor dimension between 4.0 mm and 4.4 mm,
wherein each of the two strength rods comprises a cross-sectional area between 1.22 mm² and 3.46 mm².

9. The fiber optic drop cable of claim 8, wherein, when a tensile load of 300 pounds is applied to the fiber optic drop cable for one hour, at least ninety percent of the optical fibers have an attenuation of less than or equal to 0.05 dB at 1550 nm.

10. The fiber optic drop cable of claim 8, wherein the buffer tube comprises a diameter between 2.20 mm and 3.20 mm.

11. The fiber optic drop cable of claim 8, wherein the buffer tube comprises polybutylene terephthalate.

12. The fiber optic drop cable of claim 8, wherein the two strength rods comprise glass reinforced plastic strength rods.

13. The fiber optic drop cable of claim 8, wherein the jacket comprises polyethylene.

14. The fiber optic drop cable of claim 8, further comprising a conductive tone wire.

15. A fiber optic drop cable, comprising:
a single buffer tube having a diameter between 2.20 mm and 3.20 mm;
a plurality of optical fibers disposed within the buffer tube, the plurality of optical fibers comprising two bundles of at least twelve optical fibers;
first and second strength rods respectively positioned on opposite sides of the buffer tube; and
a jacket formed around the buffer tube and the first and second strength rods, the jacket comprising an elongated cross-sectional shape with a major dimension between 8.0 mm and 9.5 mm and a minor dimension between 4.0 mm and 4.4 mm.

16. The fiber optic drop cable of claim 15, wherein, when a tensile load of 300 pounds is applied to the fiber optic drop cable for one hour, at least ninety percent of the optical fibers have an attenuation of less than or equal to 0.05 dB at 1550 nm.

17. The fiber optic drop cable of claim 15, wherein the buffer tube comprises polybutylene terephthalate.

18. The fiber optic drop cable of claim 15, wherein each of the first and second strength rods comprises a cross-sectional area between 1.22 mm² and 3.46 mm².

19. The fiber optic drop cable of claim 15, wherein the two strength rods comprise glass reinforced plastic strength rods.

20. The fiber optic drop cable of claim 15, further comprising a conductive tone wire.
